(19) United States
(12) Patent Application Publication
(10) Pub. No.: US 2024/0196869 A1
(43) Pub. Date: Jun. 20, 2024

(54) Heated Animal Water Dispenser

(71) Applicant: Multiject, LLC, Oakland Township, MI (US)

(72) Inventor: Jack E Elder, Oakland Township, MI (US)

(21) Appl. No.: 18/540,707

(22) Filed: Dec. 14, 2023

Related U.S. Application Data
(60) Provisional application No. 63/432,416, filed on Dec. 14, 2022.

(51) Int. Cl. A01K 39/026; A01K 7/02

(52) U.S. Cl. CPC A01K 39/026; A01K 7/027

(57) ABSTRACT

An animal water dispenser for use with a container for holding water includes a base, a heat source, and an upper component. The base component defines a support surface. The heat source is supported on the base component and has a heat radiating element positioned above the support surface. The upper component is removably mountable on the support surface, and defines a trough arrangement for receiving water and including an engagement feature for supporting the container on the upper component with the mouth of the container in fluid communication with the trough arrangement. The upper component is configured to radiate heat from the heat source into the interior of the container when the container is supported on the engagement feature. The upper component is configured such that at least a portion of the heat radiating element is positioned within the interior of the container.

This application claims the benefit of U.S. Provisional Patent Application Ser. No. 63/432,416, filed Dec. 14, 2022, which is incorporated herein by reference in its entirety.

### FIELD OF THE INVENTION

The present invention relates to devices for use in poultry farming. In particular, the invention relates to a water dispenser for poultry and other small animals.

### BACKGROUND

The lure of having a steady supply of fresh eggs has drawn many people to raise chickens at home, or otherwise in small scale operations. Chicken coops can be seen in suburban, and even urban, settings. Naturally, raising chickens requires providing them with a sufficient supply of food and water. Since the home poultry farm is not limited to warm climates, many home farmers must deal with the water supply freezing during the winter months. Commercial poultry farms have elaborate industrial chicken coops and water supply systems that avoid the freezing problem. But commercial and industrial water supply systems are too elaborate and expensive for small scale, home and hobbyist poultry farming.

There is a need for a water dispenser suited to a home poultry farm that addresses the problem of freezing of the water supply. The dispenser should be easy to use and inexpensive for the home farmer or hobbyist.

### SUMMARY OF THE DISCLOSURE

An animal water dispenser is provided for use with a water container, such as a one-gallon water bottle. The dispenser includes a base component configured to be supported on the ground or a surface such as the floor of a chicken coop. The base component supports a heat source, such as an incandescent light bulb, so that the heat radiating element bulb is positioned above a support surface of the base component. An upper component is mountable on the support surface and provides a trough arrangement for receiving water from the water container when the container is inverted on the upper component. The upper component includes an engagement feature for supporting the container with the mouth of the container in fluid communication with the trough arrangement. The inverted container thus fills the trough arrangement with drinking water for the animal, such as a chicken, and continuously replenishes the trough arrangement when the chicken drinks water from the dispenser.

In one feature of the dispenser, the upper component includes a radiator dome configured to extend through the mouth of the container into the interior of the container when the container is supported on the engagement feature. The radiator dome is further configured to receive at least a portion of the heat radiating element of the heat source therein so that the portion is positioned within the interior of the container when the container is supported on the engagement feature. In particular, the lower and upper components are configured so that the bulb portion of the light bulb is inside the radiator dome and inside the interior of the inverted container. When the heat source or light bulb is activated, heat generated by the light bulb radiates through the dome to heat the water inside the container to keep the water from freezing.

In another feature of the dispenser, the trough arrangement includes a central trough and three or four outer troughs extending radially outward from the central trough. The outer troughs provide access for the animal to drink the water. Each outer trough includes a thermal conductor in the form of an L-shaped plate, with one leg of the plate beneath the trough and the other leg of the plate adjacent the heat source or light bulb. The L-shaped plate is heated by the light bulb, and the heated plate then heats the water in the trough to prevent it from freezing.

The water dispenser is formed by two matable components, each formed as a one-piece component. The two components can be injection molded from a plastic, to provide a light-weight, durable and inexpensive water dispenser for the poultry farmer and hobbyist. The two components can be easily assembled with a conventional water bottle, and disassembled for refilling the water bottle or cleaning the components. The two components include mating features that protect the heating radiating element during assembly/disassembly of the dispenser. The mating features also allow the top component to easily find its functional resting position as the top component is lowered onto the bottom component.

### BRIEF DESCRIPTION OF THE DRAWINGS

FIG. 1 is a perspective view of a poultry water dispenser according to the present disclosure ready for use by a chicken.

FIG. 2 is an exploded view of the poultry water dispenser shown in FIG. 1.

FIG. 3 is a side view of the poultry water dispenser shown in FIG. 1.

FIG. 4 is a cross-sectional view of the poultry water dispenser shown in FIG. 1, with the cross-section taken along line 4-4 and viewed in the direction of the arrows.

FIG. 5 is a perspective view of a lower base component of the poultry water dispenser shown in FIG. 1.

FIG. 6 is a top view of the lower base component shown in FIG. 5.

FIG. 7 is a bottom view of the lower base component shown in FIG. 5.

FIG. 8 is a perspective view of an upper tray component of the poultry water dispenser shown in FIG. 1.

FIG. 9 is a top view of the upper tray component shown in FIG. 8.

FIG. 10 is a bottom view of the upper tray component shown in FIG. 8.

FIG. 11A-E are perspective views showing the steps for using the poultry water dispenser shown in FIG. 1.

FIG. 12 is a perspective view of a gasket that may be used in an embodiment.

FIG. 13 is a perspective view of an alternative embodiment of an upper tray component;

FIG. 14 is a cutaway view of an alternative embodiment of the dispenser of the water dispenser of FIG. 1 that employs the upper tray component of FIG. 13

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

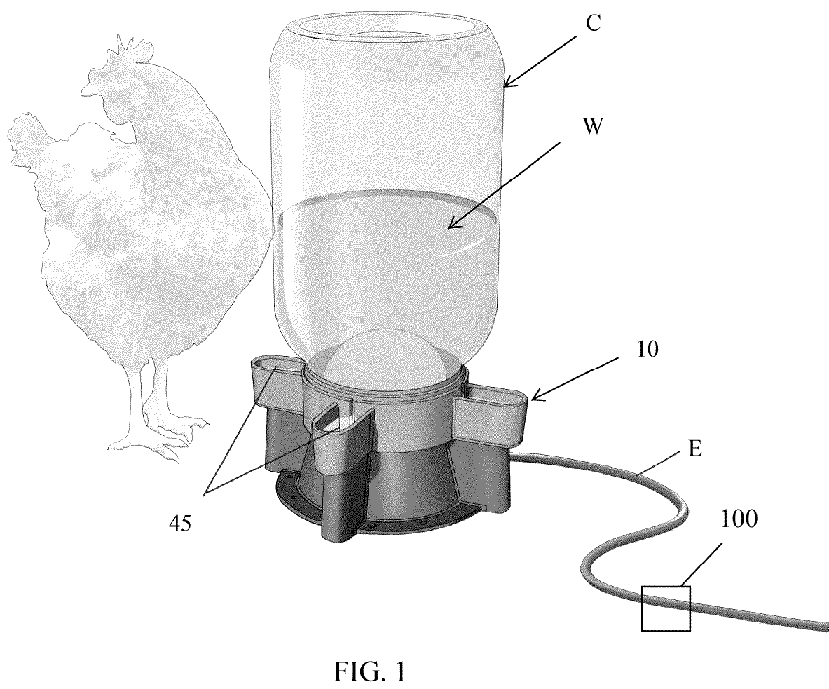

A heated water dispenser 10 for poultry is configured to support an inverted container C containing water W, as shown in FIG. 1. The dispenser includes an electrically powered heat source connected by an electrical cord E to an electrical supply, which can be a battery, AC outlet or other suitable source of electrical power. The dispenser includes a trough arrangement that holds the water for the poultry, such as the chicken shown in FIG. 1. The trough arrangement is automatically refilled with the water from the inverted container when the chicken takes a drink.

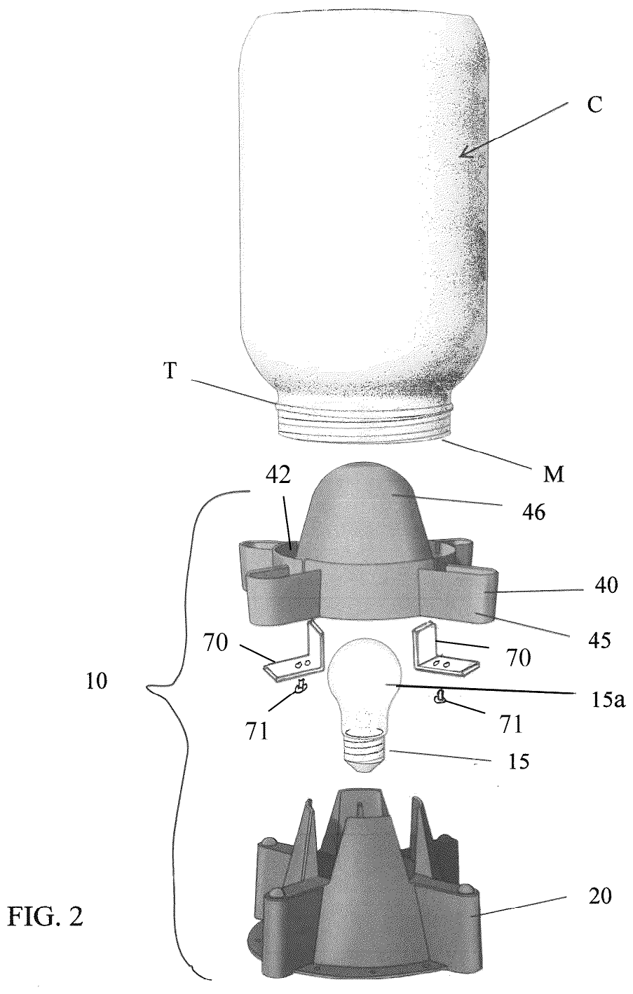

As shown in FIG. 2, the dispenser 10 includes a base component 20 that is configured to rest on a surface, such as the ground or the floor of a chicken coop. The base component supports a heat source 15 that includes a heat radiating element 15a. The heat source can be a conventional light bulb or can be other type of electrically-powered heat source, such as an induction heater. The heat source is covered by and contained within an upper tray component 40 that incorporates a trough arrangement, which includes central trough 42 and troughs 45, and a heat-conductive radiator dome 46 that separates the heat source from the water inside the inverted container C. The container C includes an enlarged mouth M with an engagement feature, such as threads T. The container C can be a conventional one-gallon bottle with a 4-inch diameter mouth and external threads. The container can be formed of any material, but is preferably formed of a plastic, such as HDPE (high-density polyethylene) or PET (polyethylene terephthalate), that is light-weight and capable of withstanding cold outdoor temperatures. The container can be clear so that the water level W inside the container can be ascertained. The dispenser also includes heat transfer components 70, which are fastened to the underside of the upper tray component 40 by screws 71, details of which are described herein.

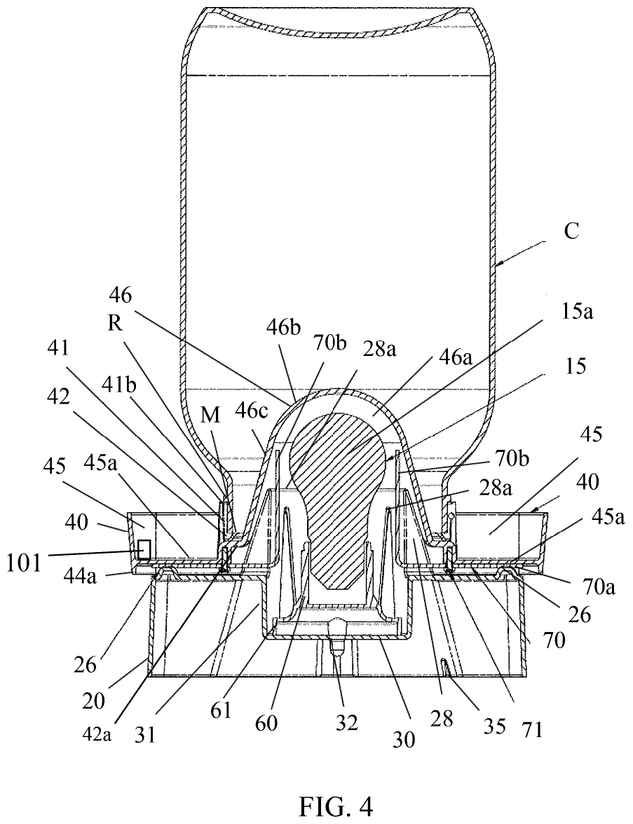

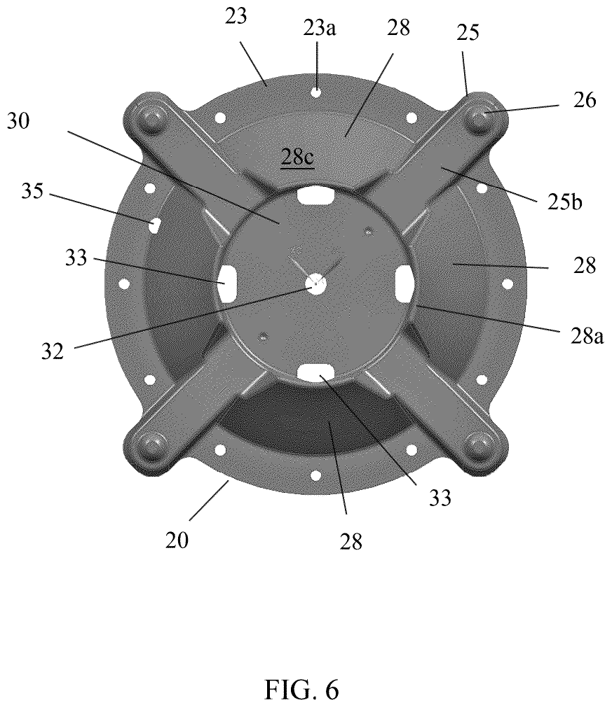

Details of the lower base component 20 are shown in FIGS. 4-7. The base component includes a body 21 that is preferably formed of a strong moldable plastic, such as nylon, polypropylene, polycarbonate and ABS. It can be appreciated that the features of the body described herein can be configured to be formed in a conventional injection molding process. The body 21 is configured to form a cavity 22 that houses the heat source 15, as described herein. The cavity 22 is defined by a base wall 30 and a cylindrical wall 31, as shown in FIG. 4. The base wall 30 includes a central aperture 32 for passage of the electrical cord E and a number of openings 33 to receive a mating component of a fixture 60 holding the heat source 15. When the heat source is a light bulb, as shown in FIG. 4, the fixture 60 can be a conventional light socket with a mounting base 61 can engages the openings 33 to support the fixture, and thus the heat source 15, within the cavity 22. The base wall 30 and cylindrical wall 31 constitute a central hub for the lower base component 20.

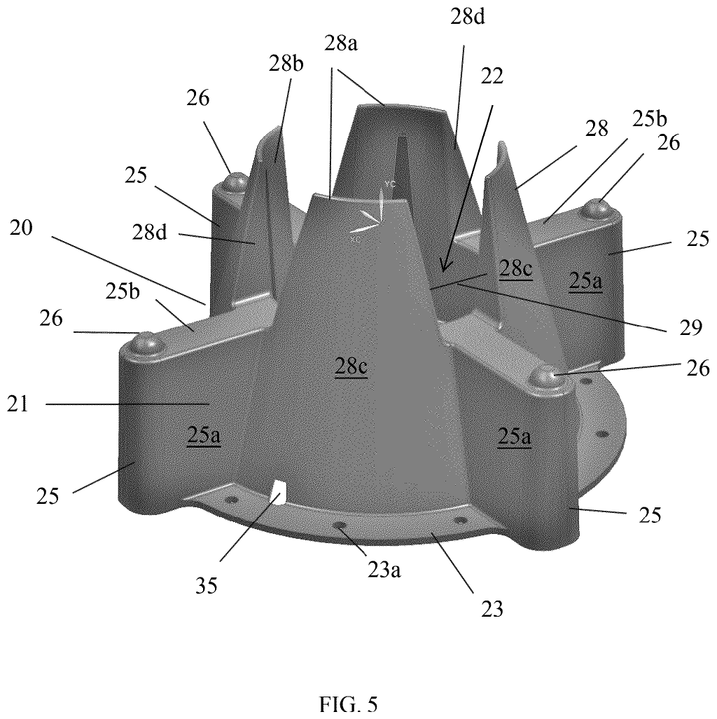

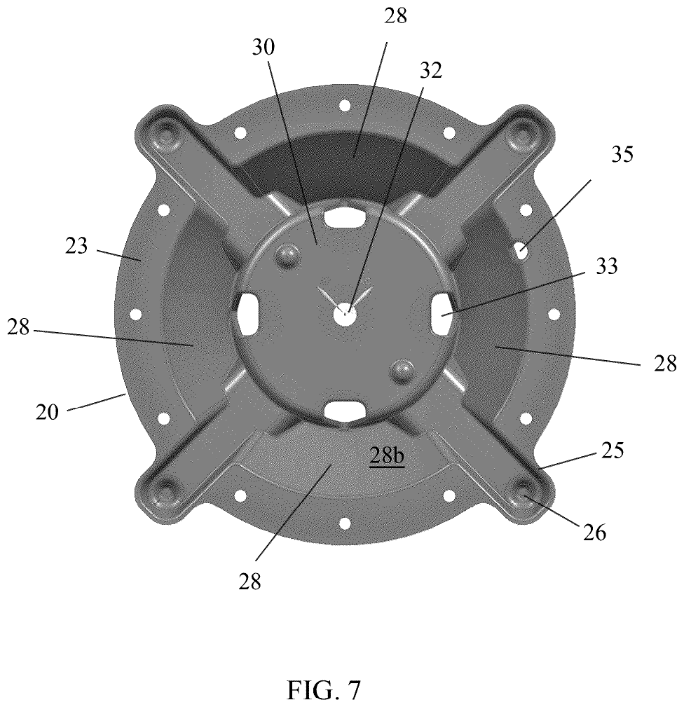

The cylindrical wall 31 of the cavity 22 integrates into body panels 28, shown best in FIGS. 4-5. The body panels 28 extend from a base plate 23, which is in the form of an annular plate or flange as best shown in FIG. 7. The base plate 23 is configured to be supported on a surface, such as the ground or the floor of a chicken coop, and can include a series of mounting holes 23a that can be used to receive anchoring elements to anchor the dispenser 10 to the surface. Thus, where the dispenser is placed on the ground, the mounting holes 23a can receive stakes driven into the ground. Alternatively, the holes can receive screws that can be threaded into the floor of the coop. At least one of the body panels 28 includes an opening 35 for passage of the electrical cord E.

In the illustrated embodiment, the body panels 28 are generally frusto-conical, tapering inward from the base plate 23 to the upper edge 28a of the panels. To improve structural integrity, the body panels 28 can include an inner wall 28b and an outer wall 28c separated by opposite side walls 28d. The inner walls 28b merge into the cylindrical wall 31 of the cavity 22, while the outer walls 28c extend to the base plate 23. Three or four such panels are provided to accommodate three or four outer troughs 45, as described below. The panels 28 are circumferentially spaced to form a gap 29 between the side walls 28d of adjacent body panels. In one embodiment, the side walls 28d can be angled so that the width of the gap 29 increases toward the upper edge 28a of the panels. As shown in FIG. 4, the body panels 28 are sized so that the upper edges 28a are lower than the heat radiating element 15a. With this feature the body panels do not impede the heat radiating from the heat source, which ensures that as much of the radiator dome 46 as possible receives the heat generated by the radiating element 15a.

Disposed between and integral with the body panels 28 are a number of wings 25 that radiate from the central hub of the lower base component 20. The wings are formed by a wrap-around side wall 25a that merges with the outer walls 28c of adjacent body panels 28 and with the base plate 23. The top of each wing 25 is closed by an upper panel 25b that merges into the side walls 28d of adjacent body panels. The wings extend outward from the cylindrical wall 31 of the cavity 22 and through the gap 29 between the adjacent body panels 28. A dimple 26 projects from the upper panel 25b of each wing 25. The lower base component includes one or more wings that extend radially outward from the wall 31. Preferably three or four wings are provided that are evenly spaced around the circumference of the wall, such as at 90° intervals for four wings or at 120° intervals for three wings. This arrangement provides a stable support for the dispenser 10 on the ground or floor that is not susceptible to tipping over during use by an animal.

It can be appreciated that the body 21 is hollow from the bottom face of the lower base component 20. This allows the base component 20 to be produced in an injection molding process, with the interior and exterior features formed by mating molds.

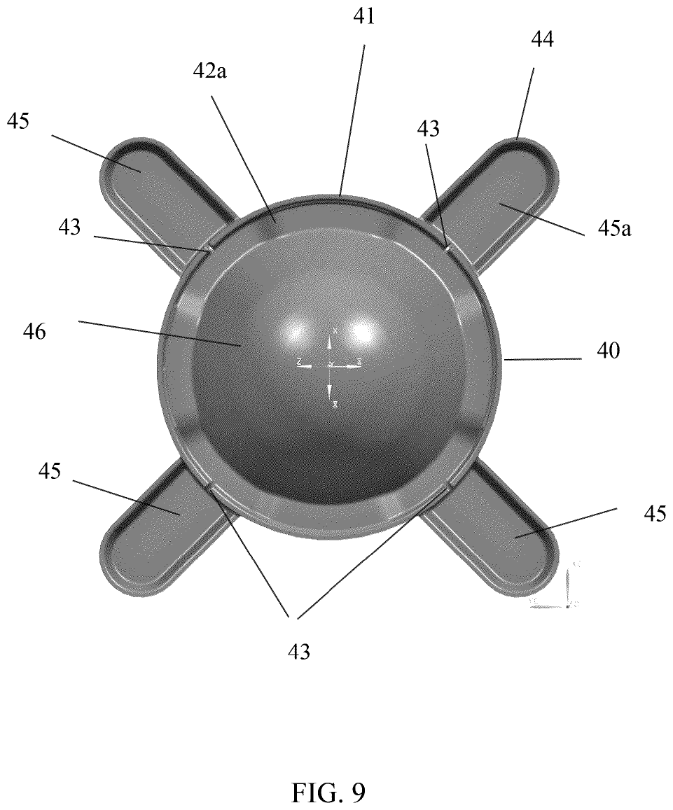

The lower base component 20 is configured to receive, support and stabilize the upper tray component 40. Details of the tray component are shown in FIGS. 4 and 8-10. Like the base component, the upper tray component is preferably formed of a plastic, such as the plastics noted above, and is configured to be formed in a conventional injection molding process. The tray component 40 includes a cylindrical wall 41 that is sized to receive the mouth end of the container C. The cylindrical wall can define a feature 41a to mate with the engagement feature T of the container, which can be internal threads adapted to mate with threads of the container. As shown in FIG. 4, the container is threaded into the cylindrical wall 41 until a circumferential rib R on the container abuts the rim 41b of the wall 41. It is contemplated that a stop can be integrated into the upper tray component to restrict how far the container is threaded into the cylindrical wall, and in particular so that the mouth M of the container is offset from the floor 42a. The mating feature 41a can be a cylindrical slip fit or interference fit that incorporates an elastomeric friction element, such as an O-ring, to engage the engagement feature T of the container.

The cylindrical wall 41 and a floor 42a define a central trough 42 of the trough arrangement that is fed by water from the inverted container. Thus, the depth of the trough 42, or more specifically the height of the cylindrical wall 41 above the floor 42a, is sized so that the mouth M of the container does not contact the floor 42a. The offset between the floor and the container mouth allows water to flow from the container into the central trough 42 until the hydrostatic pressures equalize. Since the equilibrium level for the water will be at the location of the mouth M of the container, the height of the mouth M above the floor 42a will establish the height of the water within the central trough 42, as well as in the outer troughs 45. As is known in the art, when the water level in the central trough 42 falls below the equilibrium level, water from the container flows into the trough until the equilibrium is re-established. The floor 42a intersects the cylindrical wall 41 slightly below the midpoint of the height of the wall, as shown in FIG. 4 to provide clearance for the body panels 28 of the lower base component 20 when the two components are combined.

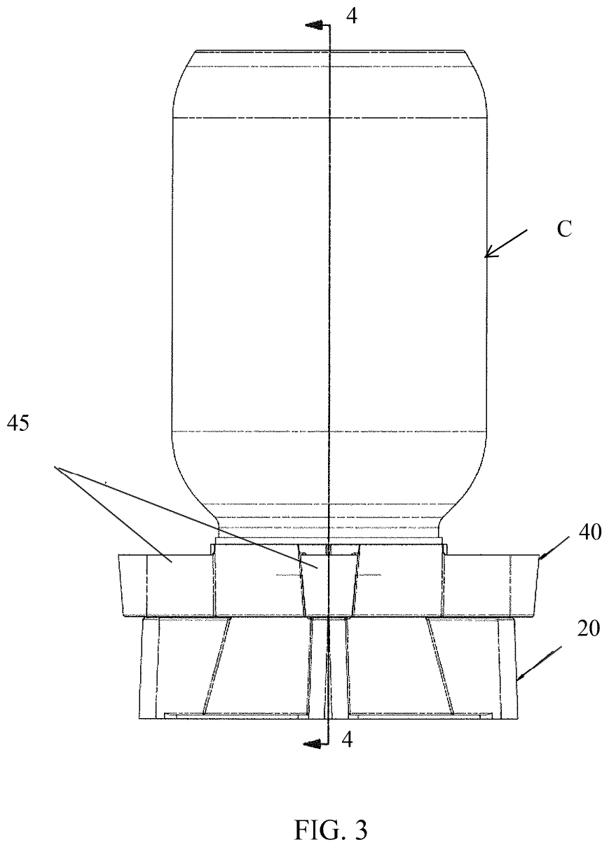

The upper tray component 40 further includes a number of outer troughs 45 of the trough arrangement that communicate with the central trough 42 through slits 43 defined in the cylindrical wall 41. The troughs 45 are defined by wrap-around side walls 44 and a floor 45a. As shown in FIG. 3, the side walls 44 can be angled outward from the floor 45a to the top of the troughs 45. In particular, the side walls can be angled to match the angle of the side walls 28d of the .side panels 28. As shown in FIG. 4, the floor 45a of each outer trough is supported on a dimple 26 of a corresponding wing 25. In certain embodiments, a heat transfer plate can be sandwiched between the upper and lower tray, as described in more detail herein. A lower skirt can be provided that overlaps the dimples 26, formed by a lower portion 41c of the central trough cylindrical wall 41 and by a lower portion 44a of the outer trough side wall 44. The floors 45a of the outer troughs 45 can be lower than the floor 42a of the central trough to provide sufficient water level in the outer troughs 45 for drinking access by the poultry. In one embodiment, the troughs can have a radial length of 2-6 inches, a width of 1-3 inches and a depth of 1-2 inches. In a specific embodiment for use by chickens, the trough is 2 inches long, 1⅛ inches wide and 1 inch deep. As noted, the floors 45a of the outer troughs are lower than the floor 42a of the central trough 42. More specifically, the floors 45a are lower relative to the mouth M of the container C supported by the upper tray component 40, so the equilibrium water level for the inverted container will fill the outer troughs about half way in the illustrated embodiment.

Like the wings 25, the outer troughs 45 extend radially outward from the cylindrical wall 41. The outer troughs can have a length greater than the length of the wings 25 so that a portion of the troughs extend beyond the wings, as shown in FIG. 4. The troughs 45 have a width that is slightly less than the gap 29 between the side walls 28d of the body panels 28 of the lower base component 20. The upper tray component 40 is thus configured to be placed on the lower base component 20 with the outer troughs 45 extending through the gaps 29 and in alignment with the wings 25. The body panels 28 thus serve to properly align the upper tray component to be supported by the lower base component. In addition, the body panels help stabilize the upper tray component when it is seated on the base component with the container C mounted to the tray component.

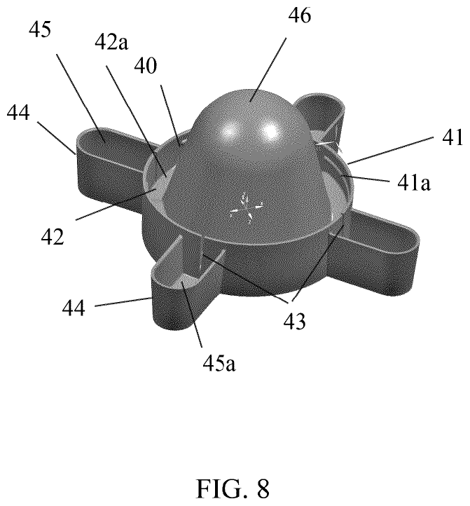

Referring to FIG. 8, the upper tray component 40 includes a radiator dome 46 projecting from the floor 45a of the trough. The dome 46 defines a cavity 46a that is sized to receive the heat radiating element 15a, as shown in FIG. 4. In one embodiment, the radiator dome includes a spherical top portion 46b that merges into a frusto-conical portion 46c that, in turn, merges into the floor 45a. This configuration maximizes the surface area of the radiator dome 46 that is exposed to the water W in the inverted container C. The configurations of the lower base component 20 and upper tray component 40 maximize the ability of the dispenser 10 to heat the water within the container, even in below freezing temperatures. The heat source 15 is supported so that the heat radiating element 15a is positioned within the interior of the container when the radiator dome is immersed in the water within the container. Heat generated by the heat radiating element 15a is conducted through the radiator dome to heat the water in all directions around the dome. The remainder of the water W within the inverted container is heated by convection. Since the heat source and radiator dome are positioned at the bottom of the inverted container, the heat will naturally propagate upward through the water in the container to prevent the water supply from freezing. As noted above, the upper tray component 40 can be formed of a moldable plastic or polymer. In some embodiments, at least the dome 46 can be formed of a polymer or plastic impregnated with a thermally conductive material, such as a metal powder, to increase the ability of the dome to conduct heat for radiation into the container of water.

In the illustrated embodiment, the base wall 30 of the cavity is below the upper panels 25b of the wings. In other words, the cavity 22, and thus the fixture 60 supporting the heat source 15, is recessed within the lower base component 20. This configuration of the lower base component 20 allows the heat radiating element 15a of a conventional incandescent light bulb to be situated within the interior of the container, as described above. Other heat sources can be used, such as an LED, a CFL (compact fluorescent lamp) bulb or a resistance cartridge. If a heat source other than an incandescent light bulb is used in the water dispenser 10, the cavity 22 and/or the fixture 60 can be configured as needed so that the heat radiating element of the heat source is positioned within the interior of the container. Thus, for a heat source that is shorter than the light bulb shown in FIG. 4, the base wall 30 may be coplanar with the upper panels 25b of the wings, or may even be upstanding from the upper panels to provide a platform to support the heat source. In any configuration, the object is to support the heat radiating element 15a above the upper panels 25b that support the upper tray component 40 so that the heat radiating element is positioned within the interior of the water container C.

It can be appreciated that the heat source 15 also heats the water in the central trough 42 due to the proximity of the central trough to the heat source. However, the outer troughs are separated from the heat source by the cylindrical wall 41, the mouth end of the container C and the dome 46. While the outer troughs are supplied by heated water from the central trough, when no poultry is drinking from the dispenser the outer troughs are not being replenished with warmer water from the central trough. In other words, for the majority of the time, the water remains untouched in the outer troughs and is only marginally heated by convection from the water in the central trough through the slits 43. In freezing conditions, this convective heat is not enough to keep the water in the outer troughs from freezing, at least unless the heat source is configured to generate much more heat. But in order for the water to be drinkable by the poultry, the temperature of the replenished water to the outer troughs cannot be very high, so a heat source that can keep the static water in the outer troughs from freezing will heat the water in the central trough to an undrinkable temperature. Moreover, the greater heat can compromise the materials of the container and two components of the dispenser 10.

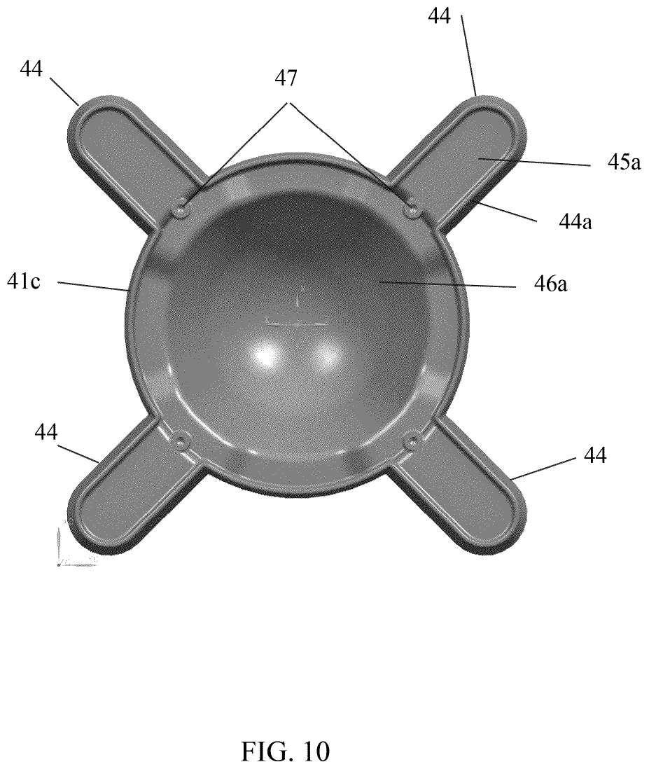

Consequently, the dispenser 10 provides a mechanism for conveying heat directly to the troughs so that the water in the troughs is heated conductively. In particular, each outer trough 45 includes a heat transfer element 70 in the form of a thermal conductor that conveys heat directly from the heat radiating element 15a to the floor 45a of the troughs. In one embodiment, the heat transfer element 70 includes a base leg 70a that extends along the floor 45a, as shown in FIG. 4. The element further includes a vertical leg 70b that extends upward within the dome 46 and adjacent the heat source 15. In one embodiment, the heat transfer element 70 is an L-shaped plate defining the two legs 70a, 70b and formed of a heat conductive material. In one specific embodiment, the material is aluminum since it is light-weight, corrosion resistant and thermally conductive. The base leg 70a is fastened to the bottom of the upper tray component 40 by screws 71 threaded into threaded bores 47 (FIG. 10) in the bottom of the component. As shown in FIG. 4, the vertical legs 70b extend beyond the upper edge of the body panels 28 and well into the dome 46 so that the legs can be directly heated by the heat source. As with the heat source, the heat transfer element is protected from the water in the central trough 42 and from the water W in the inverted container C by the radiator dome 46. The base legs 70a contact the dimples 26 when the upper component 40 is mounted on the lower base component 20 of the dispenser 10, which ensures that the base legs are in intimate heat transfer contact with the floors 45a of the outer troughs 45. It can be appreciated that the vertical legs 70b are heated by the heat source 15, and the heat is conducted to the base legs 70a underneath the outer troughs. The heat is conducted through the floors 45a to the water within the outer troughs 45 to heat the water and protect it against freezing. In some embodiments, at least the floor 45a of the outer troughs can be formed of the polymer or plastic impregnated with a thermally conductive material described above with respect to the radiator dome 40, to improve the heat conduction from the heat transfer element to the water in the troughs.

In some embodiments, a thermostat can be used to control the heat source, such as a thermostatic switch 100 in the electrical cable E. The thermostatic switch can energize the heat source 15 when the detected ambient temperature falls below 32° F. (0° C.). The switch can also be configured to de-energize the heat source when the ambient temperature is above a particular temperature, such as above freezing. Alternatively, or in addition, a thermostat can be incorporated into one of the troughs 45, such as the thermostat 101 shown in FIG. 4, or at any other suitable location in the water dispenser 10. The thermostat 101 can be electrically connected to the switch 100 to energize or de-energize the heat source as a function of the temperature of the water in the trough. Thus, if the water temperature is below a threshold temperature, such as 35° F., the heat source can be energized. On the other hand, if the thermostat 101 detects a water temperature above a different threshold, such as 60° F., the heat source can be de-energized. The thermostat can thus ensure that the water does not freeze and that the water does not become too hot for the poultry to drink. The thermostat 101 and associated switch 100 can also be configured to maintain the water in the trough at a particular temperature that is preferred by the poultry, even if the ambient temperature is not freezing. Alternatively, the water dispenser 10 can be plugged into a separate thermostatically-controlled on/off switch that would sense the ambient temperature around the dispenser, such as the temperature within a chicken coop, and control the operation of the dispenser accordingly.

The water dispenser 10 can use a conventional 100W light bulb to heat the water in the container C and in the troughs 42, 45, although lower wattages can be used if ambient conditions are not too severe. An incandescent light bulb is preferred because roughly 98% of the energy generated by the bulb is heat and not light. For a 10-20W light bulb, the surface temperature of the bulb can approach 80° F., so the water adjacent the radiant dome 46 can be heated to a temperature approaching the bulb temperature. A 10W light bulb has been found to be sufficient to keep the water in the dispenser from freezing even in below-zero ambient temperatures. An additional benefit of using a light bulb as the heat source 15 is that it can light the dispenser and surrounding area. In this instance, the container C and the radiant dome 46 must be formed of a transparent or translucent material, with a translucent material preferred for one of the container or the dome to diffuse the light from the light bulb. The heat source 15 can instead be an inductive coil that does not generate an appreciable amount of light. In this instance, the container and/or dome can be formed of an opaque material.

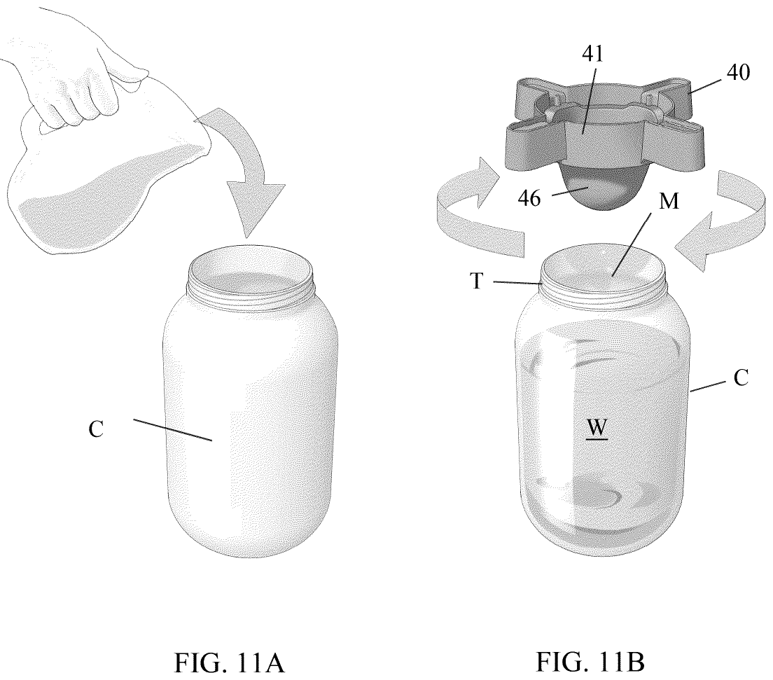

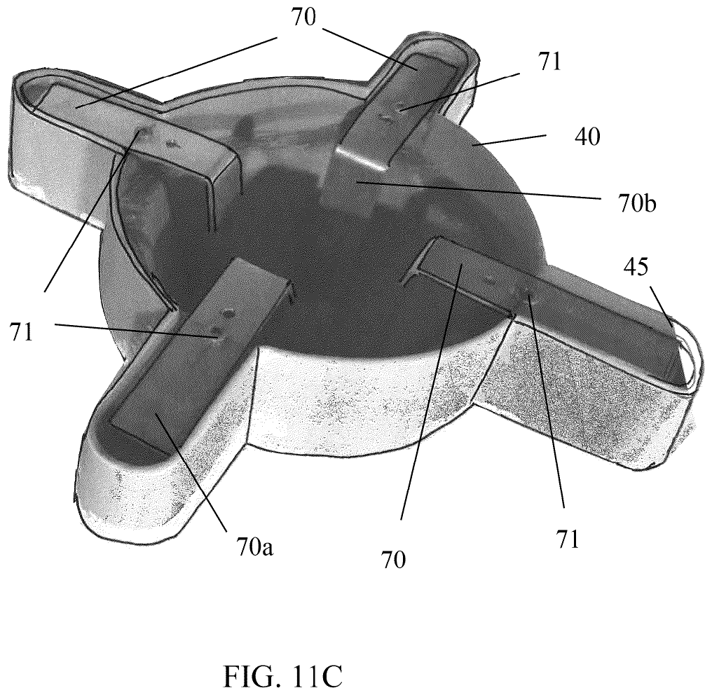

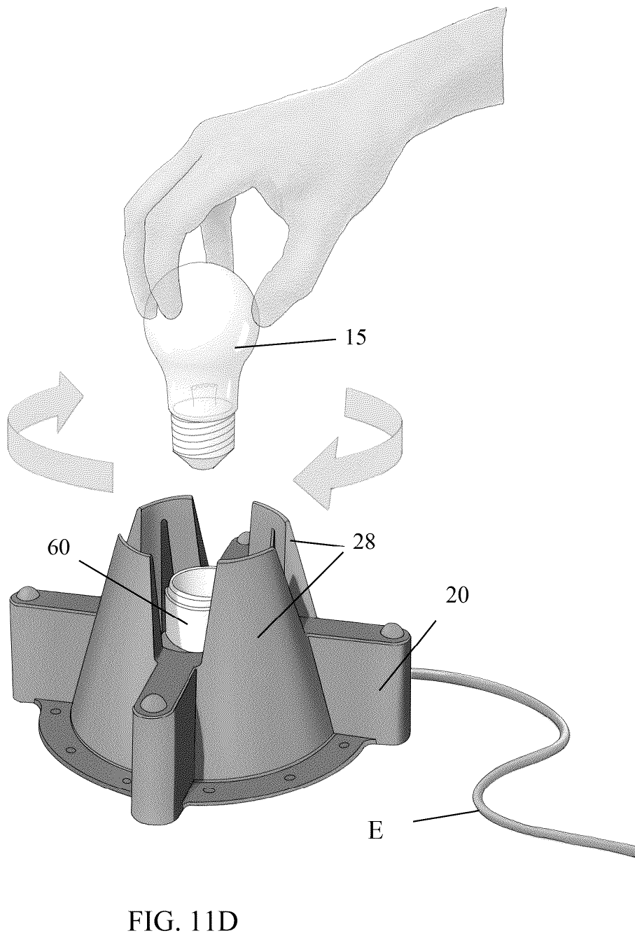

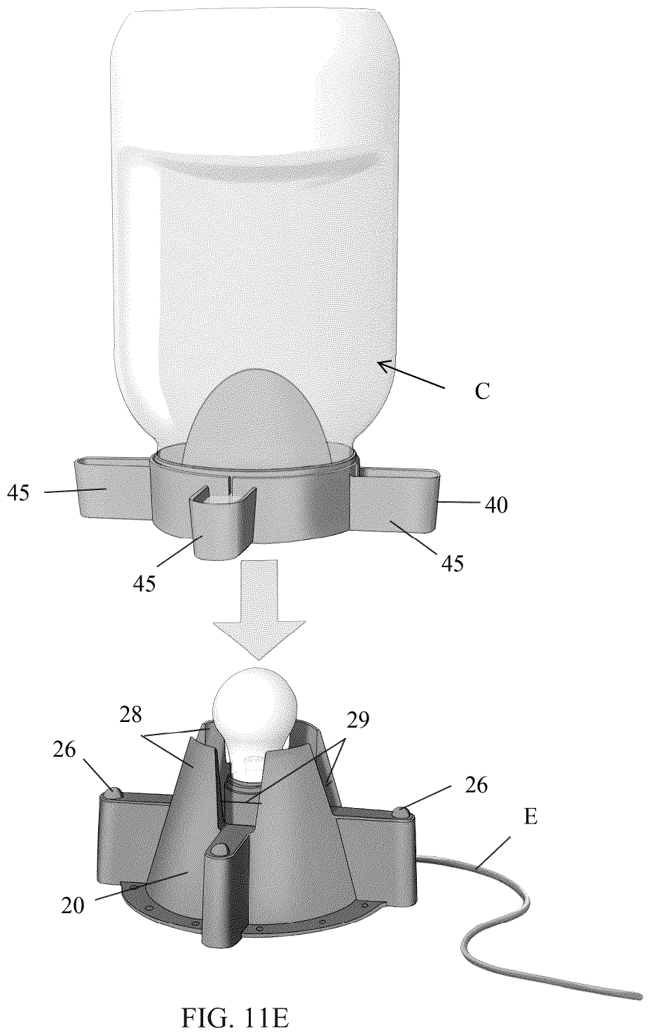

The use of the dispenser 10 is depicted in FIGS. 11A-11E. In the first step, water is poured into the container (FIG. 11A) but the container is not completely filled. Instead, the container is preferably filled about ¾ full, as shown in FIG. 11B, so that the hydrostatic equilibrium feature of the watering apparatus can be achieved. The cylindrical wall 41 of the upper tray component 40 is threaded onto the mouth M of the container C, as shown in FIG. 11B. As shown in FIG. 11C, the L-shaped heat transfer plates 70 can be fastened to the underside of the upper tray component 40, in particular by fastening the base leg 70a to the bottom of the trough 75 by screws 71. The vertical legs 70b of the plates project upward into the dome, as described above. It can be appreciated that the heat transfer plates 70 can be fastened to the upper tray component 40 before or after component has been engaged to the container C.

For the first use of the apparatus 10, the heat source 15, such as the light bulb shown in FIG. 11D, is mounted to the fixture 60 within the lower base component 20. The fixture 60 can be connected to an electrical power supply by electrical cord E. The base component 20 can be anchored to the ground or floor as described above. The container C and upper component 40 are inverted as shown in FIG. 11E, at which time the troughs 42 and 45 will fill with water from the container. The upper component is then lowered onto the lower base component 20 with the outer troughs 45 aligned with the gaps 29 between the body panels 28 until the troughs 45, or the base leg 70a of the associated heat transfer element, contact the dimples 26. No manipulation of the upper tray component 40 is necessary—the trough component with the water container mounted thereon is simply lowered onto the base component 20. The interaction of the side walls 28d of the body panels 28 with the radiator dome 46 and with the outer troughs 45 will inherently guide the troughs into alignment with the wings 25 of the base component. The completed dispenser 10 provides stable support for the inverted container, as shown in FIG. 1, with the outer troughs 45 easily accessible to the poultry for a drink. The drinking water is constantly replenished from the container in any temperature, even at below-freezing temperatures.

It can be appreciated that the geometry incorporated into both the upper component and the base component allows the components to easily find their interactive mating position as the upper tray component is lowered onto the base component. This geometry also protects the heating element, which can be a relatively fragile incandescent light bulb, during mounting and dismounting the upper component.

It can be appreciated that replenishment of the water supply or cleaning of the upper tray component 40 can be easily accomplished by simply lifting the upper component and container off of the lower base component 20. The upper component 40 can be unthreaded from the mouth of the container and the container can be refilled and/or the upper component can be cleaned. The base component 15 can also be easily cleaned by removing the heat source 15 and disconnecting the electrical cable E from the electrical source. The lower and upper components 20, 40 are light weight, yet durable enough to withstand outdoor usage. In the illustrated embodiment, the apparatus 10 is configured for use with a standard one-gallon container. However, it is understood that the lower and upper components 20, 40 can be scaled to accommodate different sizes of containers, whether smaller or large volumes. The heat source may need to be modified depending on the volume of water being heated and the desired temperature of the heated water.

It can also be appreciated that each of the lower and upper components 20, 40 is configured to be formed as one piece in an injection molding process. Thus, many of the vertical walls of the two components can be defined at conventional draft angles for injection molding. The angled vertical walls also add strength to the two components, particularly to the lower base component 20, to prevent buckling under the weight of a filled container C supported by the apparatus 10. It should also be understood that, although a preferred material for the components is a moldable plastic or resin, other materials and manufacturing methods are contemplated. Moreover, some elements of the two components can be formed of different materials. For example, the base plate 23 of the base component 20 can be a metal ring that is affixed to or overmolded into the rest of the base component. Likewise, the dimples 26 can be metal bearings overmolded into the upper panel 25b of the wings. Finally, the dimensions of the components of the water dispenser 10 can be scaled to provide a larger dispenser with a larger container C, perhaps limited by the weight of the container filled with water and the user's ability to lift and manipulate the filled container.

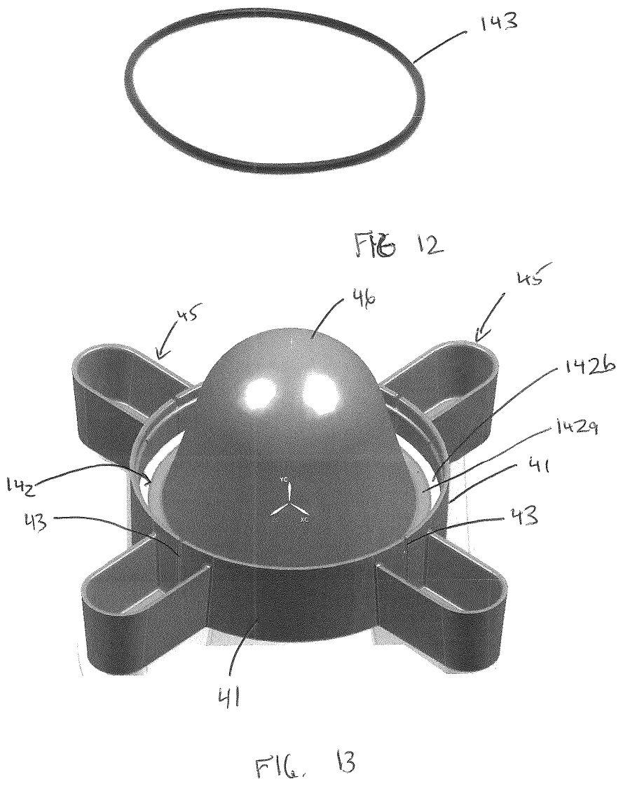

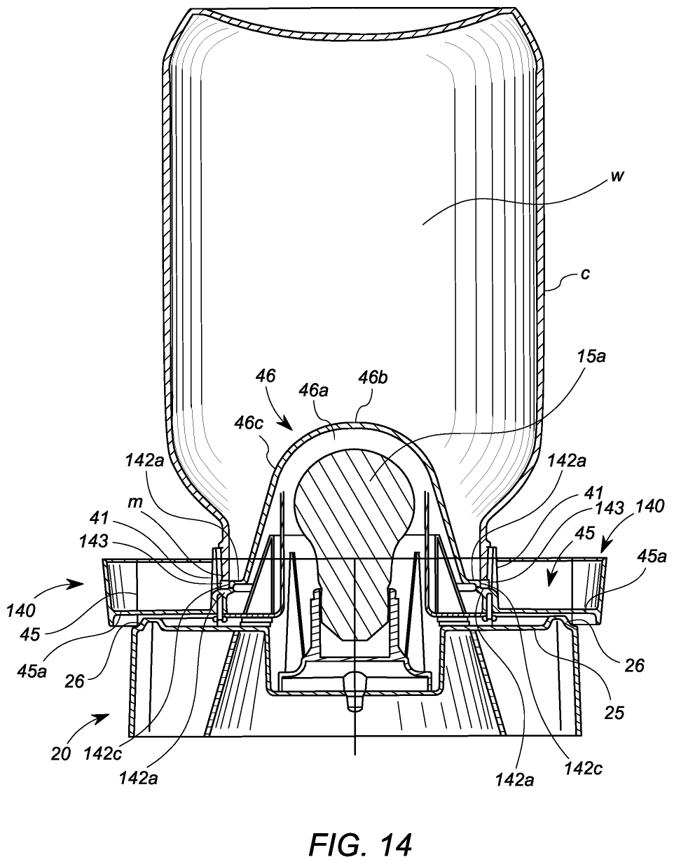

An alternative embodiment of a water dispenser 10′ is described in connection with FIGS. 12, 13 and 14. The alternative water dispenser 10′ employs the same container C and the same base component 20 as the water dispenser 10 of FIG. 1, but includes an alternative embodiment of the tray component 140. In this embodiment, a gasket 143 is employed between the container C and the tray component 140 to reduce and/or eliminate leakage or spillage during the water refill process. FIG. 12 shows a perspective view of the gasket 143, which may suitably be an o-ring polymer gasket. FIG. 13 shows a perspective view of the tray component 140 that may be used in place of the tray component 40, and FIG. 14 shows a cutaway view of the dispenser 10′, which is identical to that of FIG. 4, except that the tray component 40 has been replaced by the tray component 140, and the gasket 143 has been added. In general, the upper tray component 140 covers the heat source and incorporates a trough arrangement similar to that of the tray component 40. In this embodiment, the tray component 140 includes a central trough 142, troughs 45, and a heat-conductive radiator dome 46 that separates the heat source from the water inside the inverted container C. With the exception of the configuration of the trough 142, the tray component 140 is substantially identical to the of the tray component 40.

Details of the tray component 140 are shown in FIGS. 13 and 14. Structures on the tray component 140 that are identical to corresponding structures on the tray component 40 of FIGS. 4, 9 and 10 are identified by the same reference numbers, and operate in the same manner as discussed above. The upper tray component 140 is preferably formed of a plastic, such as the plastics noted above, and is configured to be formed in a conventional injection molding process. Like the embodiment of FIG. 4, the tray component 140 includes a cylindrical wall 41 that is sized to receive the mouth end of the container C, and can define a feature 41a to mate with the engagement feature T of the container, which can be internal threads adapted to mate with threads of the container.

In this embodiment, however, the trough 142 is configured to receive the gasket 143 therein. As shown in FIG. 14, the trough 142 is defined by a first annular shelf 142a and a lower annular shelf 142b. An axial annular wall 142c extends vertically between and connects to the first annular shelf 142a and the lower annular shelf 142b. The lower part of the cylindrical wall 41, the lower annular shelf 142b and the axial annular wall 142c cooperate to define an annular receptacle or seat for the sealing gasket 143. As will be discussed below in detail, the container C can be threadingly rotated into the cylindrical wall 41 to engage and form a fluid-tight seal with the gasket 143, so that when the container C and attached tray 140 are inverted after the refill process, water within the container C cannot spill or leak. Once in the upright position for use, the container C can be reverse-rotated to partly back the container C out of the tray 140 to release the seal (while the container C and the tray 140 otherwise remain connected) and allow water to flow from the container C to the troughs 45.

Like the tray component 40, the upper tray component 140 includes a number of outer troughs 45 that communicate with the central trough 142 through slits 43 defined in the cylindrical wall 41. The troughs 45 are defined by wrap-around side walls 44 and a floor 45a. As shown in FIG. 3, the side walls 44 can be angled outward from the floor 45a to the top of the troughs 45. In particular, the side walls can be angled to match the angle of the side walls 28d of the .side panels 28. As shown in FIG. 14, the floor 45a of each outer trough is supported on a dimple 26. In certain embodiments, a heat transfer plate can be sandwiched between the upper and lower tray, as described in more detail herein. With additional reference to FIG. 10, a lower skirt can be provided that overlaps the dimples 26, formed by a lower portion 41c of the central trough cylindrical wall 41 and by a lower portion 44a of the outer trough side wall 44. The floors 45a of the outer troughs 45 can be lower than the lower annular shelf 142b of the central trough 142 to provide sufficient water level in the outer troughs 45 for drinking access by the poultry. In one embodiment, the troughs can have a radial length of 2-6 inches, a width of 1-3 inches and a depth of 1-2 inches. In a specific embodiment for use by chickens, the trough is 2 inches long, 1⅛ inches wide and 1 inch deep. As noted, the floors 45a of the outer troughs 45 are lower than the lower annular shelf or floor 42b of the central trough 142. More specifically, the floors 45a are lower relative to the mouth M of the container C supported by the upper tray component 40, so the equilibrium water level for the inverted container will fill the outer troughs about half way in the illustrated embodiment.

Like the wings 25 of the base component 20, the outer troughs 45 extend radially outward from the cylindrical wall 41. The outer troughs can have a length greater than the length of the wings 25 so that a portion of the troughs extend beyond the wings 25, as shown in FIG. 4. The troughs 45 have a width that is slightly less than the gap 29 between the side walls 28d of the body panels 28 of the lower base component 20. The upper tray component 40 is thus configured to be placed on the lower base component 20 with the outer troughs 45 extending through the gaps 29 and in alignment with the wings 25. The body panels 28 thus serve to properly align the upper tray component to be supported by the lower base component. In addition, the body panels help stabilize the upper tray component when it is seated on the base component with the container C mounted to the tray component.

Like the tray component 40, the upper tray component 140 includes a radiator dome 46 projecting from the floor 45a of the trough. The dome 46 defines a cavity 46a that is sized to receive the heat radiating element 15a, as shown in FIG. 14. In one embodiment, the radiator dome includes a spherical top portion 46b that merges into a frusto-conical portion 46c that, in turn, merges into the floor 45a. This configuration maximizes the surface area of the radiator dome 46 that is exposed to the water W in the inverted container C. The configurations of the lower base component 20 and upper tray component 40 maximize the ability of the dispenser 10 to heat the water W within the container C, even in below freezing temperatures.

The use of the dispenser 10′ is similar to that as the dispenser 10 described above in connection with FIGS. 11A-11E. In the first step, water is poured into the container (FIG. 11A) but the container is not completely filled. Instead, the container is preferably filled about ¾ full, as discussed above. If not already disposed therein, the gasket 143 is inserted and seated into the annular receptacle formed by the annular wall 142c, the lower annular shelf 142b and the cylindrical wall 41. Thereafter, the cylindrical wall 41 of the upper tray component 40 is threaded onto the mouth M of the container C until the rim of the mouth M engages and forms a fluid tight seal with the gasket 143. This operation is illustrated in FIG. 11B, and it is noted that that the mouth M of the container C faces upward to hold the water W within the container C.

Once the steps discussed above related to FIGS. 11C and 11D are completed, the connected and sealed combination of the tray component 40 and the container C is inverted and attached to the base 20 essentially as shown in FIG. 11E, as discussed above. Thereafter, it will be appreciated that the seal provided by the gasket 143 in this embodiment does not immediately allow water to flow from the container C to the troughs 45. Accordingly, in this embodiment, rotational force is applied in the to the cylindrical wall 41 and/or the container C to loosen, and/or partially decouple the tray component 140 and the container C sufficiently to break the water-tight seal and allow water to flow from the container to the troughs 45 as otherwise discussed above in connection with the dispenser 10. By partially decoupling or loosening, it is meant that the container C and the tray 140 remain coupled, but that the water-tight seal formed by the gasket 143 and the edge of the mouth M of the container C is broken. In this position, the drinking water is constantly replenished from the container C to the troughs 45 in any temperature, even at below-freezing temperatures.

In this embodiment, the water may be refilled in the container C without resulting in leaking or spilling as the tray component 40 and container C are assembled onto the base 20 as shown in FIG. 11E.

It will be appreciated that the above-described embodiments are merely illustrative, and that those of ordinary skill in the art may readily devise their own implementations and modifications that incorporate the principles of the present invention and fall within the spirit and scope thereof. For example, it will be appreciated that water dispensers having one or more of the features described herein may be used for animals other than poultry.

What is claimed is:

1. An animal water dispenser for use with a container for holding water, the container including a mouth opening to the interior of the container, the water dispenser comprising:
a base component configured to be supported on the ground or a surface, the base component defining a support surface;
a heat source supported on the base component, said heat source having a heat radiating element positioned above the support surface when the base component is supported on the ground or a surface; and
an upper component removably mountable on said support surface when the base component is supported on the ground or a surface, said upper component defining a trough arrangement for receiving water and including an engagement feature for supporting the container on the upper component with the mouth of the container in fluid communication with the trough arrangement,
wherein the upper component is configured to radiate heat from the heat source into the interior of the container when the container is supported on the engagement feature, the upper component further configured such that at least a portion of the heat radiating element of the heat source is positioned within the interior of the container when the container is supported on the engagement feature.

2. The animal water dispenser of claim 1, wherein:
the upper component includes a radiator dome defining an interior, the radiator dome configured to extend through the mouth of the container, and
at least a portion of the heat radiating element is disposed within the interior of the radiator dome.

3. The water dispenser of claim 1, wherein the heat source is an incandescent light bulb.

4. The water dispenser of claim 3, further comprising a fixture mounted on said base component, said fixture configured to receive said incandescent light bulb.

5. The water dispenser of claim 4, wherein:
said base component defines a cavity below said support surface; and
said fixture is mounted within said cavity.

6. The water dispenser of claim 1, wherein the trough arrangement includes:
a central trough within the engagement feature; and
a number of outer troughs in fluid communication with the central trough, the outer troughs configured and arranged to be accessible by the animal to drink water within any of the number of outer troughs.

7. The water dispenser of claim 6, wherein:
the engagement feature includes a cylindrical wall defining said central trough; and
the number of outer troughs extend outward from said cylindrical wall.

8. The water dispenser of claim 7, wherein said cylindrical wall defines a number of slots therethrough, each of said number of slots opening to a corresponding trough of said number of outer troughs.

9. The water dispenser of claim 6, wherein said base component includes a number of wings corresponding to said number of outer troughs, said number of wings defining said support surface for supporting said number of outer troughs thereon.

10. The water dispenser of claim 9, wherein:
said number of outer troughs includes three or four outer troughs extending radially outward from said cylindrical wall and offset from each other around the circumference of said cylindrical wall;
said heating component is supported on a central hub of said base component, and
said number of wings includes three or four wings extending radially outward from said central hub in alignment with said three or four outer troughs when the upper component is mounted on the lower component.

11. The water dispenser of claim 6, further comprising a thermal conductor including a first portion in contact with a corresponding trough of said number of outer troughs and a second portion, wherein the thermal conductor is supported relative to the corresponding trough so that said second portion is adjacent said heat radiating element.

12. The water dispenser of claim 11, wherein first and second portions of said thermal conductor define an L-shaped plate and are formed of a thermally conductive material.

13. The water dispenser of claim 11, wherein said first portion of said thermal conductor is fixed to the corresponding trough.

14. The water dispenser of claim 1, wherein said base component includes an annular base plate that is configured to rest on the ground or a surface and is offset from said support surface.

15. The water dispenser of claim 14, wherein said annular base plate includes a number of opening therethrough for receiving anchoring elements to anchor said lower base component to the ground or a surface.

16. The water dispenser of claim 1, wherein each of said base component and said upper component is a one-piece body.

17. The water dispenser of claim 16, wherein said base component and said upper component are formed of an injection-moldable plastic or resin.

18. An animal water dispenser for use with a container for holding water, the container including a mouth opening to the interior of the container, the water dispenser comprising:
a base component configured to be supported on the ground or a surface, the base component defining a support surface;
a heat source supported on the base component; and
an upper component removably mountable on said support surface and removably connected to the container, the upper component including a plurality of trays, the upper component configured to selectively and controllably provide a seal between the interior of the container and the plurality of trays, and to alternatively and controllably provide a fluid connection between the interior of the container and the plurality of trays;
wherein the upper component is configured to radiate heat from the heat source into the interior of the container when the container is supported on the engagement feature.

19. The animal water dispenser of claim 17, wherein the upper component includes a trough fluid connected to the trays, and further comprising a gasket disposed in the trough to selectively and controllably interrupt the fluid connection.

20. The animal water dispenser of claim 18, wherein the upper component is rotatably connectable to the container.
